(19) United States
(12) Patent Application Publication
(10) Pub. No.: US 2009/0144123 A1
(43) Pub. Date: Jun. 4, 2009

(54) System and Method of Demand Modeling for Financial Service Products

(75) Inventors: Denis Malov, Scottsdale, AZ (US); Wei Sun, Hartford, CT (US)

Correspondence Address: Robert D. Atkins, 605 W. Knox Road, Suite 104, Tampa, AZ, 85284, US

(73) Assignee: SAP AG, Walldorf (DE)

(21) Appl. No.: 11/948,420

(22) Filed: Nov. 30, 2007

(51) Int. Cl. G06Q 10/00

(52) U.S. Cl. 705/10

(57) ABSTRACT

A computer system is provided which models financial products such as demand deposits and time deposits. The computer system collects transactional data related to a plurality of financial products. The demand model includes an acquisition model, average balance model, and time demand renewable model for predicting customer responses to changes in interest rate based on the transactional data. The demand model evaluates consumer response through account opening, balance variations, and time deposit renewals. The demand model can also predict effects of cannibalization, seasonality, promotions, and time-dependent demand on the financial products. The cannibalization model estimates model parameters by demand group level, categorical level, and multicurrency level. The interest rate is optimized for each of the financial products by utilizing one or more of the acquisition, average balance, time demand renewable, cannibalization, seasonality, promotional, and time-dependent models. The optimized interest rate is exported to a financial institution.

### FIELD OF THE INVENTION

The present invention relates in general to economic modeling and, more particularly, to a system and method of demand modeling for financial service products.

### BACKGROUND OF THE INVENTION

Economic and financial modeling and planning is commonly used to estimate or predict the performance and outcome of real systems, given specific sets of input data of interest. An economic-based system will have many variables and influences which determine its behavior. A model is a mathematical expression or representation which predicts the outcome or behavior of the system under a variety of conditions. In one sense, it is relatively easy, in the past tense, to review historical data, understand its past performance, and state with relative certainty that the system's past behavior was indeed driven by the historical data. A much more difficult task, but one that is extremely valuable, is to generate a mathematical model of the system which predicts how the system will behave, or would have behaved, with different sets of data and assumptions. While forecasting and backcasting using different sets of input data is inherently imprecise, i.e., no model can achieve 100% certainty, the field of probability and statistics has provided many tools which allow such predictions to be made with reasonable certainty and acceptable levels of confidence.

In its basic form, the economic model can be viewed as a predicted or anticipated outcome of a mathematical expression, as driven by a given set of input data and assumptions. The input data is processed through the mathematical expression representing either the expected or current behavior of the real system. The mathematical expression is formulated or derived from principles of probability and statistics, often by analyzing historical data and corresponding known outcomes, to achieve a best fit of the expected behavior of the system to other sets of data, both in terms of forecasting and backcasting. In other words, the model should be able to predict the outcome or response of the system to a specific set of data being considered or proposed, within a level of confidence, or an acceptable level of uncertainty.

Economic modeling has many uses and applications. One emerging area in which modeling has exceptional promise is the financial services industry. Banks, credit unions, savings and loan, commercial lenders, investment houses, and brokerage firms face stiff competition for limited customers and business. Most if not all financial service institutions make every effort to maximize sales, volume, revenue, and profit. Economic modeling can be an effective tool in helping management achieve these important goals.

One modeling tool of use to financial service institutions involves estimating price elasticity for money deposit accounts such as savings accounts, checking accounts, money market deposit accounts (MMDA), and certificates of deposit (CD). The process of setting interest rates or prices for bank deposit and loan accounts is an essential task for financial service institutions. Some large institutions have used sophisticated analytics and modeling to understand demand trends and uncover areas of profit opportunity. Automated pricing software represents a movement toward greater precision in the pricing process. The software relies on complex demand models to estimate customers' attitudes toward price and the elasticity of demand from historical sales data. The demand models create parameters which can be used to optimize deposit interest rates and generate volume forecasts.

One problem in demand modeling is the existence of products that have little or no historical data. A similar problem is found when there are no price changes in the sales history of a product, or if a price does change, it is associated with a promotion, competitor price move, or cost change. In the latter case, there is little information about the effect of pure price changes on consumer demand. The lack of information makes traditional regression analysis unstable and can result in incorrect price elasticities.

One possible solution involves a statistical method called Bayesian inference. Bayesian inference is an approach in determining stable and robust parameter estimates by taking into consideration the learning from prior distributions of the corresponding parameter estimates. Bayesian inference methods require the knowledge of a priori guesses for the model parameters. The guesses define what is known about the model parameters prior to observing the data used for modeling. During the modeling process, these guesses are used in a way similar to “attractor points” for the parameters estimated by demand models, thus stabilizing the modeling process. Such methods can be thought of as a mathematical approach to mixing facts or data with educated guesses, also known as priors. The quality of Bayesian priors is important to obtain accurate estimates of model parameters.

There are existing techniques of determining Bayesian priors. One classic technique is to use expert opinion for the values of priors. The expert opinion may be obtained from professionals in the field who have studied some aspects of the modeling objects in question. Another technique uses aggregated values from a related, larger data set to determine the priors. However, these traditional techniques may not be feasible or efficient in determining Bayesian priors for price elasticity in a financial service environment where one would like to systematically, automatically, and quickly obtain the priors for a large number of products. In some cases, the expert opinion is too expensive to obtain or simply not available in time considering the dynamic movement of thousands of financial products. In other cases, related data sets are difficult to find, for example, when a new product line is introduced and hence no historical data can be used as a reference.

Moreover, the procedure for forming the estimates is time and labor intensive. It is most difficult for a financial analyst to see the global effect of an interest rate change without a careful analysis of all the potential channels through which that change may impact portfolio performance.

A need exists for an economic model for estimating price elasticity for financial services such as interest rates on deposit accounts.

### SUMMARY OF THE INVENTION

In one embodiment, the present invention is a computer-implemented method of modeling a financial product comprising the steps of collecting transactional data related to a plurality of financial products, and providing a demand model to predict customer responses to changes in interest rate. The demand model includes an acquisition model for quantifying relationships between the financial products and interest rates and predicting volume for the financial products based on the transactional data, an average balance model for quantifying relationships between temporal average balances of the financial products and interest rates based on the transactional data, and a time demand renewable model for quantifying relationships between probability of renewals and interest rates for the financial products based on the transactional data. The method further includes the steps of optimizing interest rates for the financial products utilizing the demand model, and exporting the optimized interest rates to a financial institution.

In another embodiment, the present invention is a computer-implemented method of modeling a financial product comprising the steps of collecting transactional data related to a plurality of financial products, providing a demand model including an acquisition model, average balance model, and time demand renewable model for predicting customer responses to changes in a financial product attribute based on the transactional data, optimizing the attribute for the financial products by utilizing one or more of the acquisition model, average balance model, and time demand renewable model, and exporting the optimized attribute to a financial institution.

In another embodiment, the present invention is a computer program product usable with a programmable computer processor having a computer readable program code which collects transactional data related to a plurality of financial products, provides a demand model including an acquisition model, average balance model, and time demand renewable model for predicting customer responses to changes in a financial product attribute based on the transactional data, optimizes the attribute for the financial products by utilizing one or more of the acquisition model, average balance model, and time demand renewable model, and exports the optimized attribute to a financial institution.

In another embodiment, the present invention is a computer system for modeling a financial product comprising means for collecting transactional data related to a plurality of financial products, means for providing a demand model including an acquisition model, average balance model, and time demand renewable model for predicting customer responses to changes in a financial product attribute based on the transactional data, means for optimizing the attribute for the financial products by utilizing one or more of the acquisition model, average balance model, and time demand renewable model, and means for exporting the optimized attribute to a financial institution.

### BRIEF DESCRIPTION OF THE DRAWINGS

FIG. 1 is a block diagram of a process of modeling and controlling a financial service system;

FIG. 2a illustrates graphs of deposit rate and number of new accounts as a function of time;

FIG. 2b illustrates graphs of deposit rate and percent renewal as a function of time;

FIG. 3a illustrates graphs of cannibalization between CD products as a function of time;

FIG. 3b illustrates graphs of average interest rates between CD products as a function of time;

FIG. 4a illustrates graphs of cannibalization between MMDA products as a function of time;

FIG. 4b illustrates graphs of average interest rates between MMDA products as a function of time;

FIG. 5 is a block diagram illustrating three levels of cannibalization for a bank deposit portfolio;

FIG. 6 is a graph of promotional impact on deposit volume as a function of time;

FIG. 7 is a graph of seasonal trend of deposit volume as a function of time;

FIG. 8 is a block diagram of the demand modeling and interest rate optimization system;

FIG. 9 is a computer system for executing the demand model and interest rate optimization process; and

FIG. 10 illustrates a process of modeling a financial product.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Economic and financial modeling and planning is an important business tool which allows companies to conduct business planning, forecast demand, model revenue, and optimize price and profit. Economic modeling is applicable to many businesses such as manufacturing, distribution, retail, medicine, chemicals, financial markets, investing, exchange rates, inflation rates, pricing of options, value of risk, research and development, and the like. In the face of mounting competition and high expectations from investors, most if not all businesses must look for every advantage they can muster in maximizing market share and profits. The ability to forecast demand, in view of pricing and promotional alternatives, and to consider other factors which materially affect overall revenue and profitability is vital to the success of the bottom line, and the fundamental need to not only survive but to prosper and grow.

In particular, economic modeling is essential to businesses which face thin profit margins. Clearly, many businesses are keenly interested in economic modeling and forecasting, particularly when the model provides a high degree of accuracy or confidence. Such information is a powerful tool and highly valuable to the business.

The present discussion will consider economic modeling as applied to financial service industry. In particular, the model provides insight into the cause and effect behind customer decisions to purchase financial products, such as money deposits and loans, based on interest rates, econometric environment, individual product attributes, such as term, liquidity, penalties, cannibalization, seasonal patterns, and promotions. The model provides an understanding of consumer behavior and decisions which is necessary to increase the profitability of the financial institution. The present demand modeling and optimization system addresses effective modeling techniques for various financial products, in terms of forecasting and backcasting, and provides tools for a successful, scientific approach to programs with a high degree of confidence.

Financial service institutions, such as banks, credit unions, savings and loan, commercial lenders, investment houses, and brokerage firms, offer a wide variety of financial products and services to the consumer. These products include money deposits, interest-bearing checking accounts, loans, and investment services. The financial institutions conduct countless transactions each business day and collect volumes of transactional data. With proper modeling, the historical transactional data can provide useful information as to consumer buying decisions, patterns, behavior, and influence of external factors.

In one example, the financial institutions are keenly interested in optimizing interest rates for money deposits. The money deposits are essential to maintaining sufficient cash reserves to extend loans and earn interest on those loans. The financial institutions desire to maximize money deposits while paying the minimum interest on the deposits. By paying the optimal interest which maximizes total deposits at the least cost, the financial institution is able to increase revenue by having more money to lend and increase profitability as the difference between the amount earned from the loan and the amount paid for the deposit. Accordingly, financial service institutions use economic modeling to increase revenue and profitability.

As stated, an important function of the financial service institution is to accept deposits from customers for the purpose of lending. In fact, depositors are the major stakeholders of the banking system. While various deposit products and services offered by banks are assigned different names in different countries, these deposit products and services can be broadly categorized into the following types. A demand or checkable deposit is a deposit received by a bank which is withdrawable on demand. Checking or current accounts are a typical demand deposit product. A savings deposit is a form of demand deposit which is subject to restrictions as to the number and the amount of withdrawals permitted by a bank during any specified period. Typical savings deposit products in the United States are various savings accounts and money market deposit accounts (MMDA). A time or term deposit is a deposit received by a bank for a fixed period, withdrawable only after the expiration of that fixed period. Certificates of deposit (CDs) are a typical example of time deposit products. Savings and time deposits pay interest, but cannot be used directly as money. The savings and time deposit accounts allow customers to set aside a portion of their liquid assets, to be used to make purchases in the future, in an account earning a monetary return.

Unlike savings and time deposits where the primary reason for depositing money is to generate interest, the main function of a demand deposit account is transactional. Therefore most banks either pay no interest or pay a very low rate of interest on credit balances, and charge various fees such as monthly maintenance fees and money transfer fees. Large financial service institutions typically offer lower deposit rates but charge higher service-related fees than do smaller institutions.

For many financial institutions, the growth of loans has outstripped growth of deposits. As interest rates continue to fluctuate and the yield curve to flatten, financial institutions have experienced tremendous margin pressure and thus discovered the importance of effective core deposit pricing in terms of optimizing interest rates and other product attributes to achieve strategic profitability growth goals.

In the following discussion, the term “bank” refers generically to financial service institutions. In order to understand its deposit business and correctly price its deposit products, every bank wants to evaluate the rate-volume trade-off, and to forecast total volume and other key performance indicators (KPI) of deposits for each pricing portfolio. Product pricing generally refers to setting and preferably optimizing the interest rate offered for each financial product. Moreover, to make any strategic pricing policies meaningful, demand must be forecasted accurately at both product and segment levels. Therefore, it is important for banks to utilize demand modeling methods and systems that can accurately isolate and quantify interest rate elasticity at the product level.

Banks offer many deposit products for customers to choose. For example, a bank may offer and charge different rates for CDs with different terms (from one week to multiple years), balance tiers (dollar amount of deposit, e.g., $1,000 or $10,000), features (opt-up, risk-free), programs (premium or regular), currencies (any country currency), customer type (individual, government, small business), and promotion types (intro rate, special rate). Banks charge a different interest rate for each combination of these attributes, which is referred to as a deposit product or pricing unit in the modeling system.

Banks must also model the entire lifecycle of deposit products. There are at least three customer responses to a change in deposit interest rate: account opening or acquisition, balance variation or average balance, and time deposit renewal. Banks may adopt a statistical model to estimate the price impact on total volume and/or origination volume, and use data averaging to obtain information regarding balance variation and time deposit renewal. In reality, the changes in interest rate have different impacts on each of the three phases of an account's life, which means these changes show different rates of responsiveness and demand patterns. Thus, in order to accurately measure the demand sensitivity to the interest rate, it is important to break down the overall response to interest rate changes into the individual above-noted responses and model each separately to provide more insight into the consumer's response to an interest rate change, which helps to quantify any marketing and sales activities.

To accomplish the above goals, a computer-implemented demand model is presented to estimate the impact of interest rates and other factors on bank deposit volume, including deposits such as checking and savings accounts, CDs, and MMDA. The demand model estimates price elasticity of demand and other model parameters, and predicts the total volume of deposits for each pricing portfolio. In particular, the demand model includes three econometric models to predict three unique consumer behaviors: account opening or acquisition, balance variations or average balance, and time deposit renewals. The demand model accurately quantifies the relationship between bank deposit volume and deposit rate by examining interest rate changes in historical transactional data and models the changes in KPI as a function of changes in rates for each financial product.

The demand model notes the changes in KPI, such as originations, average balance, and renewal probability, as a function of changes in interest rate for each product segment. The combined volume-rate trade-off information can be used in what-if analysis, or in a sophisticated optimization process to generate the optimal interest rate for each deposit product in a deposit portfolio to achieve enterprise level strategic goals. The demand model generates volume forecasts for each pricing portfolio at different rates.

The demand model accurately and simultaneously models all three types of consumer responses to an interest rate change on a deposit product. The model provides an ideal framework for fine-tuning pricing to maximize profit and/or achieve other strategic goals by helping to guide pricing managers in setting the right trade-offs between various financial product offerings. In addition to the primary application, the demand model is useful when used to analyze competitors' prices to understand how the competitor views the price sensitivity of its products.

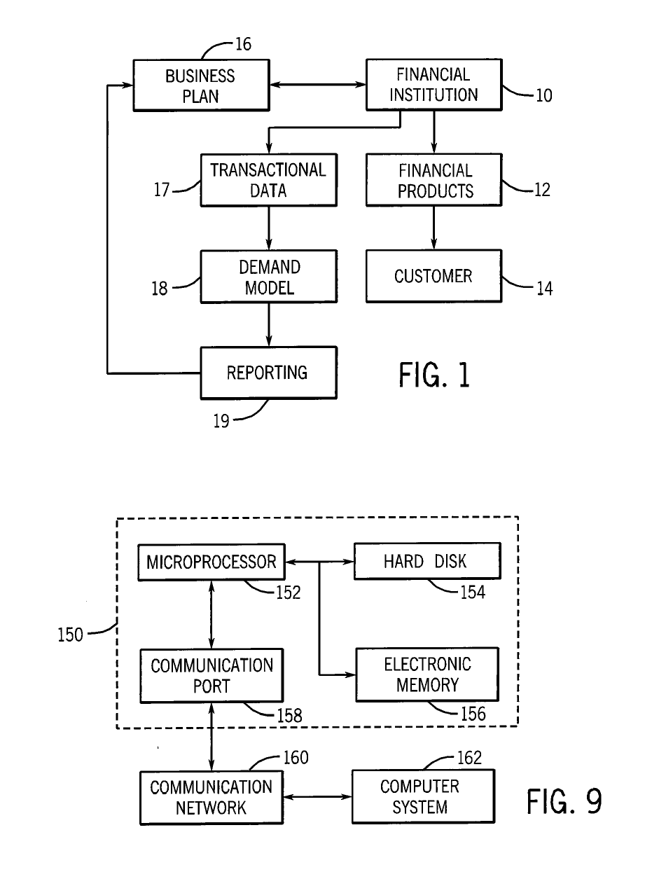

In FIG. 1, a financial service institution (bank) 10 offers certain financial product lines and services 12 available to customers 14 as part of its business plan. The terms of products and services are interchangeable in the present application. The product lines and services 12 include savings accounts, MMDA, CDs, interest bearing checking, loans, and investment options. Bank 10 has the ability to set pricing, fix interest rates, offer promotions, collect and maintain historical transactional data, and adjust its strategic business plan. The management team of bank 10 is held accountable for market share, profits, and overall success and growth of the business. While the present discussion will center on bank 10, it is understood that the promotional, modeling, and optimization tools described herein are applicable to other industries and businesses having similar goals, constraints, and needs. The model works for any product/service which may be promoted by the business. Moreover, the model can be used for many other decision processes in businesses other than financial services such as described above.

Bank 10 has business or operational plan 16. Business plan 16 includes many planning, analyzing, and decision-making steps and operations. Business plan 16 gives bank 10 the ability to evaluate performance and trends, make strategic decisions, set interest rates, formulate and run promotions, hire employees, expand branches, add and remove product lines, and the like. Business plan 16 allows bank 10 to analyze data, evaluate alternatives, run forecasts, and make operational decisions. Bank 10 can change business plan 16 as needed. In order to execute on business plan 16, the management team needs accurate economic demand models 18. In one application of the subject demand model, the methodology of the model is applied to financial services, e.g., determining optimal interest rates, so that bank 10 can make important operational decisions. The optimal interest rate maximizes deposits and cash reserves to make loans to customers 14, while paying the least interest rate for the deposits in order to maximize profits as the difference between the interest earned on the loans and the interest paid on the deposits.

From business plan 16, bank 10 provides certain observable transactional data and assumptions 17, and receives back specific forecasts, predictions, and reporting from demand model 18. The transactional data originates from day-to-day financial transactions involving financial products 12 between bank 10 and customer 14. Transactional data 17 includes customer attributes, relevant financial product, interest rate, terms, promotions, date and time, and branch. The model performs a series of complex calculations and mathematical operations to predict and forecast the business functions in which bank 10 is most interested. The output of demand model 18 is a report, chart, table, or other analysis 19, which represents the model's forecasts and predictions based on the model parameters and the given set of data and assumptions. Report 10 is made available to business plan 16 so that bank 10 can make operational decisions.

Each financial product 12 has a unique set of attributes. For example, a money deposit product has term, liquidity, early withdrawal penalty, customer type, and promotion. For each money deposit product, demand model 18 determines model parameters, evaluates price elasticity, and generates volume forecast.

In the process of formulating model parameters, demand model 18 determines Bayesian priors for price or reference elasticity by adopting a combination of reverse engineering techniques to derive priors of price elasticity from profit function and current price as well as utilizing prior knowledge from a variety of available sources. The Bayesian priors can also be used in price optimization scenarios that are not necessarily optimal for profit optimization, but may still be acceptable to bank 10 due to additional KPIs considerations.

For money deposits such as checking accounts, savings accounts, and MMDAs, the demand model organizes transactional data by account opening, account existing, and account closing. For time deposits such as CDs, the demand models organize transactional data by account opening, account renewal, and early withdraw. The model uses a variety of methodologies or techniques to fit the transactional data in each category and estimate the interest rate elasticity of demand for each deposit product.

In one aspect, the demand model is designed to capture the origination volume for any deposit products, either checking or savings deposit or time deposit products. The model also explains variations of the average balance for each demand and savings deposit product. Finally, the model accounts for the renewal probability of CDs or any other type of time deposit products. These aspects of the model are applicable not only to interest rates, but also to other factors such as macroeconomic index and competitor index to explain the changes in deposit volume. The above modeling results are combined to provide a complete and accurate estimation of price impact on the bank's deposit portfolio.

Once the estimated values of all model parameters are obtained, the model computes volume or other KPI forecasts for each product in the deposit portfolio at different rates. The combined volume-rate trade-off information can be used in “what-if” analysis or be used in an optimization system to generate the optimal interest rate for each loan.

To accurately estimate the rate-volume trade-off, it is necessary to model customer buying behavior at each phase in the lifecycle of the deposit account. The buying behaviors through a deposit product lifecycle include applying for a new account, putting in additional funds for a checking or savings account, and renewing a time deposit account at maturity. In modeling customer buying behavior, the demand model uses three separate econometric models: an acquisition model, average balance model, and time deposit (TD) renewal model, to accurately model all three types of consumer responses to interest rate changes. Demand model 18 gives bank 10 the option of using any one, two, or all three of the models to predict customer buying behavior, particularly with respect to changes in interest rates as applied to financial products 12. The demand model captures three distinct consumer buying behaviors and produces accurate estimates of interest rate elasticity of demand for each deposit product so that the modeling results can be used in deposit interest rate optimization and what-if analysis.

The acquisition model identifies and quantifies the relationship between numbers of new accounts and interest rates, and predicts the origination of deposit volume for each product. The acquisition model determines the correlation between interest rates and deposit accounts. The expression for a modeled number of new accounts for a given deposit product i as a function of rate and independent variables without considering potential cannibalization effects, is given by equation (1) as:

$${N}_{i} ( t ) = exp ( {\sum }_{k} {β}_{k} {x}_{k} ( t ) ) \qquad ( 1 )$$

where: Nᵢ is the modeled number of new accounts for a particular deposit product i;
xₖ denotes a set of independent variables with k=1, 2, 3, . . . ;
βₖ denotes a set of corresponding parameters for each independent variable.

The dollar volume is computed as the product of the average deposit amount at the account opening and the number of new accounts. The independent variables xₖ typically include interest rate, competitor rates, and macroeconomic index, such as treasury bill rate or prime interest rate. The explanatory variables used in the acquisition model for savings and time deposit products include interest rate, competitor index, and macroeconomic index. The directional impact for the interest rate on origination volume is positive. The directional impact for the competitor index on origination volume is negative. The directional impact for the macroeconomic index on origination volume is mixed.

The explanatory variables used in the acquisition model for checking account products are determined in a different manner because service charges on deposit accounts or fees have become an important source of bank revenues on transaction accounts. Since customers pay a relatively large number of fees, such as monthly maintenance fee and transaction fees for checking accounts, and receive either no interest or a very low level of interest on credit balances, they are likely to consider both the interest rate and the fee charges in choosing where to open their checking accounts. Accordingly, the acquisition model for checking products includes an additional explanatory variable, referred to as fee equivalent rate (FER), to account for the trade-off between fee charges and deposit volume. The FER indicates the level of the fee charges as compared with the average balance. The FER is computed by dividing each account fee payments by the monthly or weekly balance and averaging the ratio over all accounts associated with one checking product, as given in equation (2):

$$F E R = {\sum }_{i}^{n} \frac{\frac{fee {payments}_{i}}{average {balance}_{i}} \times 100 \%}{n} \qquad ( 2 )$$

where: “i” is one account within a checking product.

The explanatory variables used in the acquisition model for checking products include interest rate, FER, competitor index, and macroeconomic index. The directional impact for the interest rate on origination volume is positive. The directional impact for the FER on origination volume is negative. The directional impact for the competitor index on origination volume is negative. The directional impact for the macroeconomic index on origination volume is mixed. These explanatory variables are the default independent variables in the acquisition model. Bank 10 has the freedom to combine the interest rate and FER to develop a no-fee equivalent rate variable if it believes that the latter can better explain the trend in deposit volume.

The average balance model accounts for deposits and withdrawals from existing accounts. The average balance model isolates and quantifies the relationship between the weekly or monthly average balance of the savings and checking product and its interest rate. The average balance model predicts the average balance amount expected to be maintained by customer 14 per week or month for each savings deposit product. The average balance model accommodates the fact that the origination amount for the saving account does not necessarily reflect the true average balance amount subsequent to the opening. Moreover, the average balance has a different degree of sensitivity to changes in interest rate compared with origination amount. Therefore, the average balance model is able to capture the unique demand characteristics of this type of variable. Combining the original amount and average balance creates a true balance amount and represents a more accurate way to model the rate-volume trade-off for savings deposit products.

In the average balance model, the dollar volume is computed as the product of the balance tier amount and the balance tier utilization ratio. The balance tier amount refers to the maximum amount of deposit for each balance tier. Different banks have different structures of balance tiers. A bank may have several tiers, e.g., 3 to 7 tiers with each tier varying from say $500 to $1 million. Each balance tier has an interest rate no lower than the next lower tier. For example, a bank offers three interest rates for three balance tiers in a savings deposit product: 2% for 0 to $2,500, 3% for $2,500 to $10,000 and 4% for $10,000 to $1 million. The balance tier amounts are $2,500, $10,000 and $1 million.

The balance tier utilization ratio is defined as the ratio of total balance averaged over all accounts in a product per balance tier over that balance tier amount. The expression for balance tier utilization ratio (U) for a given savings product as a function of rates, is given in equations (3) and (4) as:

$$\begin{matrix}U = \frac{average balance}{balance tier amount} \times 100 \% & ( 3 ) \\ {U}_{i} ( t ) = \frac{exp ( {\sum }_{k} {β}_{k} {x}_{k} ( t ) )}{1 + exp ( {\sum }_{k} {β}_{k} {x}_{k} ( t ) )} & ( 4 )\end{matrix}$$

where: Uᵢ is the modeled balance tier utilization ratio for a particular savings deposit product i;
xₖ denotes a set of independent variables with k=1, 2, 3, . . . ;
βₖ denotes a set of corresponding parameters for each independent variable.

The independent variables xₖ include interest rate, competitor rates, and macroeconomic index, such as treasury bill rate or prime interest rate. The explanatory variables used in the average balance model for savings and time deposit products include interest rate, competitor index, and macroeconomic index. The directional impact for the interest rate on utilization volume is positive. The directional impact for the competitor index on utilization volume is negative. The directional impact for the macroeconomic index on utilization volume is mixed.

For checking account products, the explanatory variables further include FER which is determined by equation (2).

The TD renewable probability model captures the unique demand pattern of TD renewals. The TD renewable probability model identifies and quantifies the relationship between the probability of TD renewals and interest rates, and predicts the probability of TD renewals for possible interest rate changes on the TD account. The dollar volume of TD renewals is computed as the product of the average dollar amount of the TD product, the number of TD accounts up for renewal, and the modeled renewal probability.

CDs are a typical TD product that cannot be withdrawn for a certain term or period of time. Other TD products include short deposits, fixed deposits, monthly income certificates, and quarterly income certificates. When the term is over, the funds can be withdrawn or held for another term. The longer the term the better the yield on the TD account. Since TDs are usually subject to automatic renewal at maturity, the interest rate sensitivity for renewal is in general relatively weaker than that for acquisition or new money.

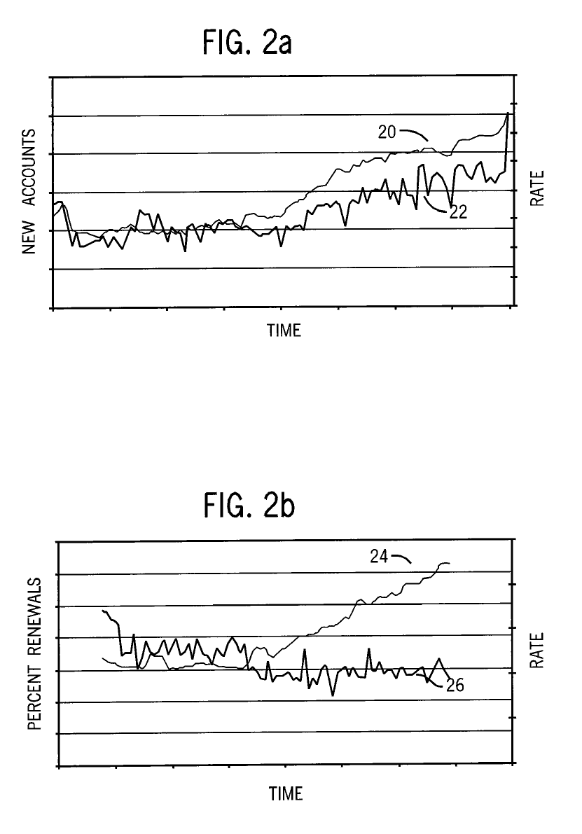

FIG. 2a illustrates deposit rate and number of new accounts and the expected responsiveness to interest rate changes. The interest rate sensitivity for new accounts is shown through an average rate by graph 20. The number of new accounts is shown by graph 22. In general, as the interest rate increases, the number of new accounts also increases. In FIG. 2b, the deposit rate and CD account renewal percentage is shown. The renewal accounts have weaker responsiveness to interest rate changes. The interest rate sensitivity for accounts renewals is shown through an average rate by graph 24. Percentage of account renewals is shown by graph 26. In general, increasing interest rate does not have a strong correlation to account renewals.

The TD renewal probability is defined as the ratio of the number of renewed accounts over the number of up-for-renewal accounts for a time deposit product in a specific time period. The number of up-for-renewal accounts can be inferred from each account's opening date and its deposit term within a product segment. The expression for modeled probability of TD renewals (P) for a given product as a function of rate, is given in equations (5) and (6) as:

$$\begin{matrix}P = \frac{number of renewed accounts}{number of up \text{-} for \text{-} renewals accounts} & ( 5 ) \\ {P}_{i} ( t ) = \frac{exp ( {\sum }_{k} {β}_{k} {x}_{k} ( t ) )}{1 + exp ( {\sum }_{k} {β}_{k} {x}_{k} ( t ) )} & ( 6 )\end{matrix}$$

where: Pᵢ is the modeled probability of TD renewals for a particular time deposit product i;
xₖ denotes a set of independent variables with k 1, 2, . . . k;
βₖ denotes a set of corresponding parameters for each independent variable.

The independent variables xₖ includes interest rate, competitor rates, and macroeconomic index, such as treasury bill rate or prime interest rate. The explanatory variables used in the TD renewal probability model include interest rate, competitor index, and macroeconomic index. The directional impact for the interest rate on renewal volume is generally positive. The directional impact for the competitor index on origination volume is negative. The directional impact for the macroeconomic index on origination volume is mixed.

One major challenge of accurately forecasting deposit demand is to properly model cross-elasticity, also known as cannibalization effect between different financial products. With limited consumers and sources of money, the concept of cannibalization applies to bank deposits in that the sale of one product, e.g., one-year time deposit, affects the volume of sales of another similar-by-demand-characteristic product, e.g., two-year time deposit. The cannibalization impact on demand for each deposit product is important for volume forecasting and estimation of price elasticity of demand. Consumers can easily utilize Internet tools to move money into and out of various deposit accounts, and thus take advantage of various high-yield financial products. Cannibalization between deposit products can manifest itself at different levels such as demand group level (group of similar deposit products differentiated by terms), categorical level (CDs and MMDAs), and multicurrency level (US dollar vs. Euro accounts). The final impact of cannibalization is computed as the combined effect of the three levels of cannibalization. For example, if a Hong Kong bank raises its interest rate only on its six-month US dollar CDs, it will immediately generate more deposits for this particular product through new acquisitions, but it will also likely cause a drop in the volume of its three-month or one-year CDs, a decrease in the balance of its saving accounts and MMDAs, and observe a movement of money out of its Euro or pound sterling accounts into the US dollar CD accounts. If cannibalization only occurs at one of the three levels, then the model estimates the values of cannibalization parameters only at that level.

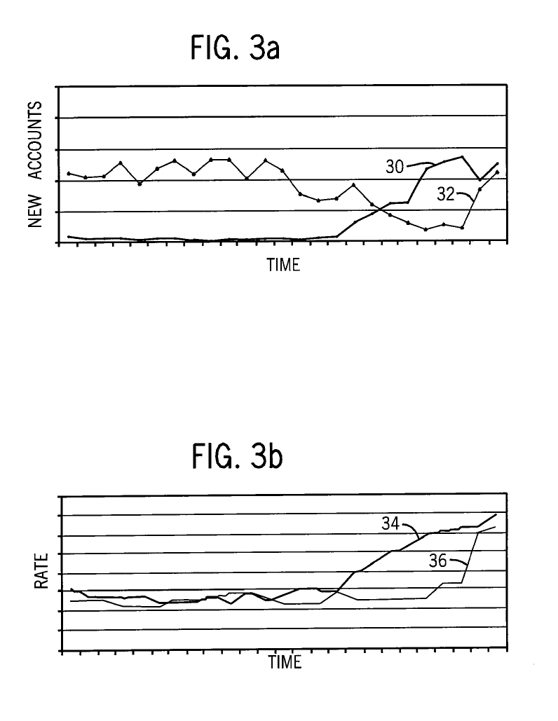

The effect of cannibalization on each product is part of volume forecasting and an accurate measure of interest rate elasticity. For bank deposits, the sale of one product, e.g., one-year TD, may adversely affect the volume of sales of another product, e.g., two-year TD. FIG. 3a shows cannibalization between two CD products. The number of new accounts for the first CD product is shown as graph 30; the number of new accounts for the second CD product is shown as graph 32. The graphs 30 and 32 show clear cannibalization between the CD products. FIG. 3b shows average rates between two CD products. The interest rate for the first CD product is shown as graph 34; the interest rate for the second CD product is shown as graph 36. When the interest rate for the second CD product increases, the sales volume of the second CD product begins to decline. When the interest rates for the second CD product begins to catch up to the interest rate for the second CD product.

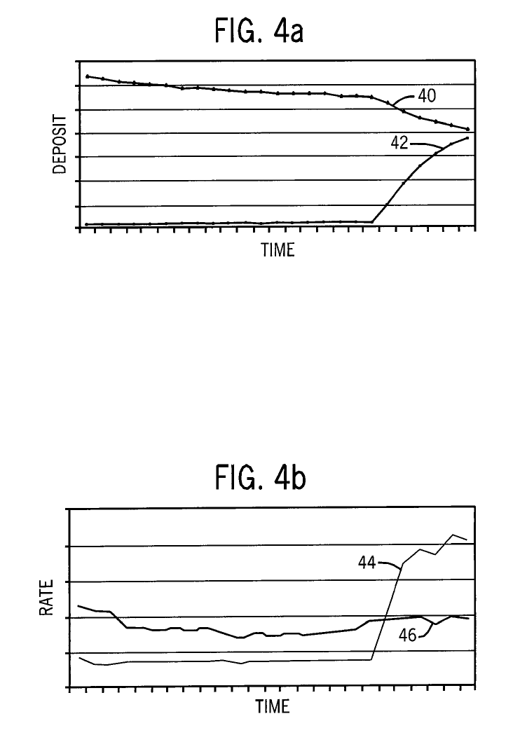

FIG. 4a shows cannibalization between two MMDA products. The number of deposits for the first MMDA product is shown as graph 40; the number of deposits for the second MMDA product is shown as graph 42. FIG. 4b shows average rates between the MMDA products. The interest rate for the first MMDA product is shown as graph 46; the interest rate for the second MMDA product is shown as graph 44. When the interest rate for the second MMDA product increases, the number of deposits of the second MMDA product increases. The increase in deposits for the second MMDA product matches a corresponding decrease in deposits for the first MMDA product, which demonstrates cannibalization between the MMDA products. The cannibalization effect is pervasive in banking and affects demand at the product level. For example, the cannibalization effect exists among deposits with different terms and among different categories, such as CDs, money market and regular saving accounts.

In order to forecast the cannibalization effect, it is necessary to obtain accurate estimates on cross-price elasticity. To forecast the volume of product P1, assuming that historically product P2 cannibalizes product P1. The demand model is given by equation (7) as:

V₁=exp(β₀+β₁×P₁+β₂×P₂) (7)
where: V is volume;
Pᵢ is price for a particular product i;
βₖ denotes a set of corresponding parameters for each independent variable.

In equation (7), β₁ approximates price elasticity and β₂ approximates cross-price elasticity. Once the estimate of β₂ is obtained from historical data, queries such as understanding the impact on the volume of product P1 by raising the interest rate of product P2 by a given percentage can be determined. The model in equation (7) can be readily expanded from two products to “n” products over a certain period of time.

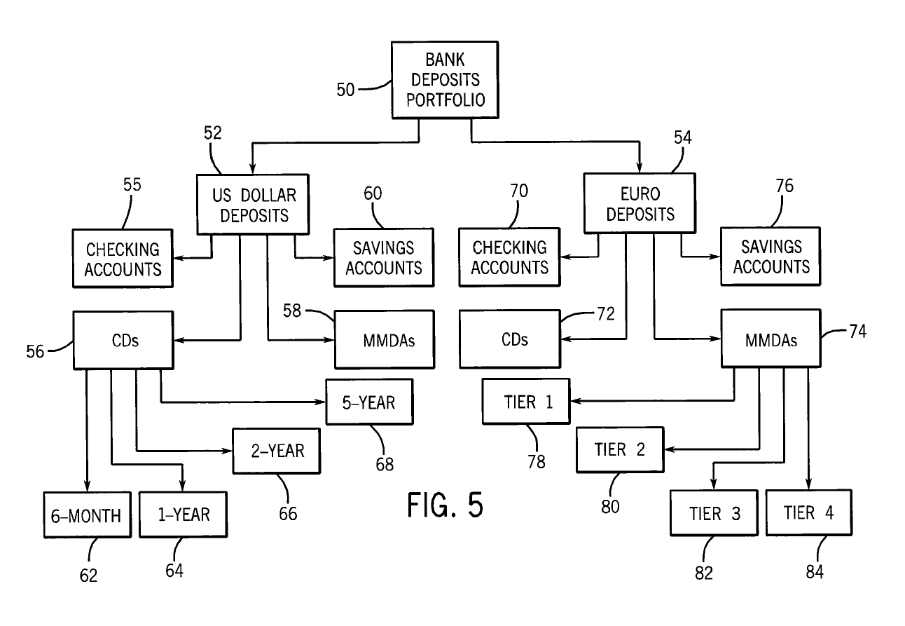

FIG. 5 illustrates the three levels of cannibalization effect for bank deposits portfolio 50. Bank deposits portfolio 50 has US dollar deposits 52 and Euro deposits 54. US dollar deposits are further sub-divided into types of deposits such as checking accounts 55, CDs 56, MMDAs 58, and savings accounts 60. Each type of deposit will have attributes. For example, CDs 56 include six-month duration CDs 62, one-year duration CDs 64, two-year duration CDs 66, five-year duration CDs 68, and so on. Likewise, Euro deposits 54 are further sub-divided into types of deposits such as checking accounts 70, CDs 72, MMDAs 74, and savings accounts 76. Each type of deposit will have attributes. For example, MMDAs 74 have tier 1 MMDAs 78, tier 2 MMDSs 80, tier 3 MMDAs 82, tier 4 MMDAs 84, and so on.

A demand group is a collection of fairly substitutable products with common demand characteristics, e.g., all the products in the demand group have similar seasonal behavior, and all the products in the demand group have a similar cannibalization effect. For banking, a demand group may contain all CD products within the same balance tier and customer type but with different terms. Another demand group is a group of MMDA products that have different features.

The deposit category includes the four common deposit types shown in FIG. 5, i.e., checking accounts, CDs, MMDAs, and saving accounts. Some countries have additional deposit types. In the European banking system, there are also recurring benefit deposits, short deposits, fixed deposits, monthly income certificates, and quarterly income certificates.

Cannibalization at the multi-currency level is applicable for banks which offer deposit products in domestic and foreign currencies. A United Kingdom (UK) bank may offer a pound sterling savings account as well as a Euro account at the same time. A Hong Kong bank may offer deposit products denominated in US dollars, Hong Kong dollars, and Chinese Yuan.

If a bank raises the interest rate on a one-year US dollar CD product, the demand will likely increase, but at the same time the volume of a different term US dollar CD, such as a six-month or two-year CD will likely decrease. Moreover, the balance of savings accounts and MMDAs may also decrease as customers are taking advantage of the one-year US dollar CD offer. Finally, if foreign exchange rates remain constant, customers may start converting other currencies into US dollars and transferring that money into the one-year US dollar CD product, which will likely lower the deposit volume balance of other related currencies.

In order to capture these complex interactions, demand model 18 uses a multi-phase modeling process to capture cannibalization. The model first estimates the cannibalization impact at the demand group level, then moves up to the categorical level and finally to the multi-currency level. The final effect is calculated as the combined impact of these three levels of cannibalization.

In the first step, demand model 18 uses a cannibalization function to estimate the impact of an interest rate change of one product on the demand for other related products in the same demand group. The cannibalization function can take on various functional forms. Some of the commonly utilized for consumer choices modeling functional forms originate from multinomial logit distributions. For example, cannibalization coefficient due to multiple consumer choices within demand group can be introduced as follows. First, equation (8) defines Z(t) as the sum over modeled acquisition volume at time t for an entire demand group.

$$Z ( t ) = {\sum }_{j = 1}^{N} {V}_{j} ( t ) \qquad ( 8 )$$

where: j is one deposit product in a demand group;
N is number of deposit products in demand group;
t is time

If Z is an average of Z(t) over all time, generally weighted to favor more recent time, then the cannibalization function C_{D}(t) at demand group level can be introduced by equation (9) as:

$${C}_{D} ( t ) = \frac{1}{( {Z}_{D} ( t ) / {Z}_{D} ) ϕ + ( 1 - ϕ )} \qquad ( 9 )$$

In equation (9), the cannibalization parameter φ measures the relative strength of cannibalization effect due to changes in one of the product's volume (potentially induced by pricing activities as changes in product's rate or promotional activity) on the demand of other products in the same demand group. Since introduced function Z(t) represents all products within the demand group, the cannibalization function describes cannibalization effects common to all products within the demand group.

In the next step or phase of the cannibalization effect, C_{C}(t) quantifies the interaction among deposit categories, such as saving accounts, MMDAS, and CDs, according to equation (10).

$${C}_{C} ( t ) = \frac{1}{( {Z}_{C} ( t ) / {Z}_{C} ) ϕ + ( 1 - ϕ )} \qquad ( 10 )$$

where: Z_{C}(t) is the sum of deposit volume across all categories;
Z_{C} is the average of Z_{C}(t) over time

Given the product hierarchy, the relationship between the deposit volume at demand group level and at deposit category level is demonstrated by equation (11). The variable Z_{D}_{_{—}}ᵢ(t) is the volume of a demand group i associated with a deposit category Z_{C}(t) at a time period.

$${Z}_{C} ( t ) = {\sum }_{i = 1}^{N} {Z}_{D\_i} ( t ) \qquad ( 11 )$$

In the consequent step, if cannibalization is observed at multi-currency level, a cannibalization function, C_{M}(t) is constructed to represent product to product substitution effect, as per equation (12). Again, the cannibalization function at the multi-currency level may take on various functional forms depending on the specific market conditions and institutional factors that influence the cannibalization pattern, such as the foreign exchange system and the difference between foreign and domestic interest rates.

$${C}_{M} ( t ) = \frac{1}{\begin{matrix}( {E}_{f} / {E}_{c} ) {γ}_{e} + ( {R}_{f} / {R}_{d} ) {γ}_{r} + \\ ( {Z}_{M} ( t ) / {Z}_{M} ) ϕ + ( 1 - {γ}_{e} - {γ}_{r} - ϕ )\end{matrix}} \qquad ( 12 )$$

where: E_{f} is the future exchange rate;
E_{c} is the spot exchange rate;
R_{f} is the average foreign interest rate;
R_{d} is the average domestic interest rate;
Z_{M}(t) is the sum of deposit volume across all currencies;
Z_{M} is the average of Z_{M}(t) over time;
φ, γₑ and γᵣ are model parameters.

If cannibalization occurs only at the demand group level, then only the first cannibalization function is needed for the demand modeling. If two or three levels of cannibalization are observed, then the final impact of cannibalization is computed either as the combined effect, denoted by C_{M}(t), or through multiple cannibalization functions as shown in equation (13) depending on utilized functional forms.

C_{F}(t)=C_{D}(t)×C_{C}(t)×C_{M}(t) (13)

The above described models for acquisitions, average balance, and utilization are further modified by the appropriate cannibalization functions to better explain and predict demand for each product in equations (14)-(16).

D_{N}(t)=C(t)×Nᵢ(t) (14)

D_{U}(t)=C(t)×Uᵢ(t) (15)

D_{P}(t)=C(t)×Pᵢ(t) (16)

Demand groups, categories, and currency segments are created in demand model 18 through product linking where the three levels are generated and linked for each bank. The levels from product through multi-currency are a true hierarchy with each product belonging to one demand group that may contain many products. In turn, each demand group belongs to one category which may contain many demand groups, and each category belongs to one currency segment which may contain many categories.

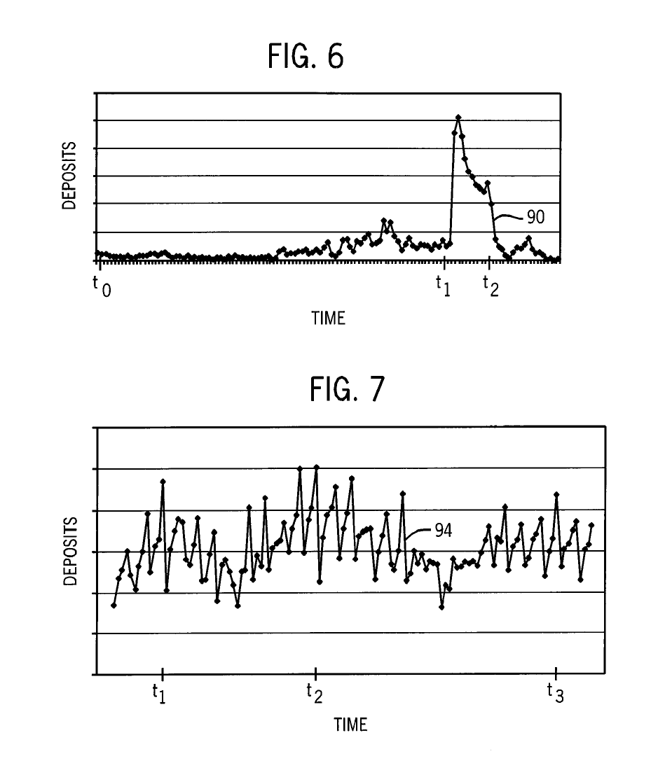

To prevent non-price factors from obscuring estimation of interest rate elasticity of demand and to generate accurate volume forecasts, the model estimates impact of promotions and time-dependent demand (TDD), which refers to demand variations that are due to cyclical or seasonal demand, growth trends, or special events. The demand model uses a statistical approach to model effects of promotional activities and TDD. Bank 10 may offer temporary or introductory rates, reduced fees, and direct money rebates to attract customers to open a deposit account. The sales generated through such promotions have different demand characteristics from regular sales. FIG. 6 illustrates promotional impact on deposit volume 90. Regular sales occur between times t0 and t1, while a promotion takes place between times t1 and t2. In demand model 18, the effect of a promotion is typically represented by promotional lift factor v. The promotional lift factor v represents the extra lift in deposit volumes from the promotion alone, i.e., sales that do not arise from changes in deposit interest rates. The promotional lift factor v could be a complex function or a single parameter as demonstrated in the model given by equation (17).

$$Z ( t ) = {\sum }_{j = 1}^{N} exp ( {β}_{j} {X}_{j} ( t ) + v ) \qquad ( 17 )$$

The TDD model captures demand variations due to cyclical or seasonal fluctuations, growth trends, or special events such as holidays, and irregular volume at month-end and year-end. FIG. 7 illustrates seasonal trend of deposit volume 94. The increases in deposits, for example at times t1, t2, and t3, can be attributed to seasonal events. The seasonal lifts are typically slow varying components of overall deposit demand. In modeling TDD, time series modeling techniques are typically used such as given in equation (18).

$$ln ( TDD ( t ) ) = {\sum }_{i} {s}_{i} {x}_{i} + κ ( t - τ ) + α R ( t ) \qquad ( 18 )$$

where: xᵢ is time-dependent seasonal dummies;
(t−τ) is linear growth or decline trends;
R(t) is econometric index;
sᵢ is model parameter for seasonal dummies;
κ is model parameter for linear trend;
α is model parameter econometric index

The above model assumes normally distributed residual noise. To compensate for any underlying non-stationary processes, the model is extended by including auto-regressive integrated moving average (ARIMA) and/or state-space modeling terms.

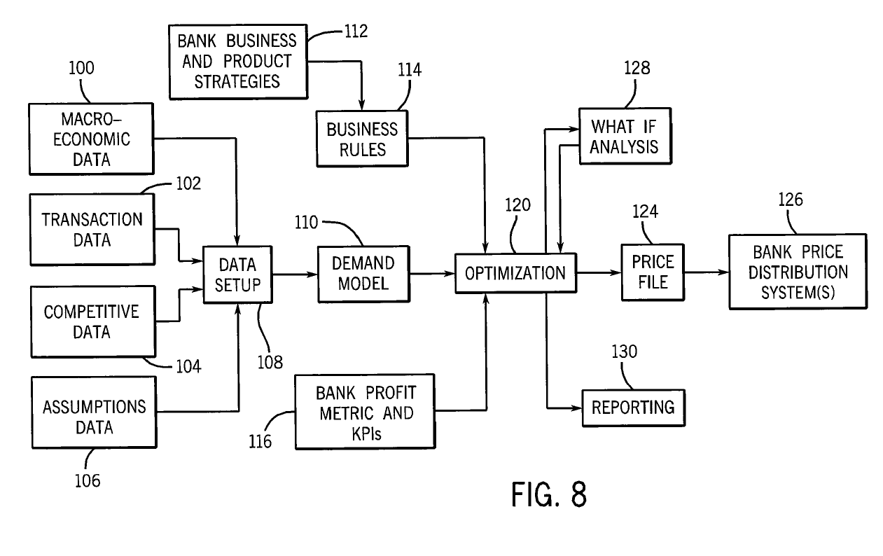

FIG. 8 illustrates the structure of an interest rate optimization system. Bank 10 collects large amounts of transactional data including macroeconomic data 100, transaction data 102, competitive data 104, and assumptions data 106, which are fed into data setup 108. Other input data can include product definition and model hierarchy. Data setup 108 identifies, sorts, and stores the data into a database. Data setup 108 further organizes the data according to product definitions and modeling requirements for demand model 110. For example, data setup 108 may construct a geographical region hierarchy and links products according to bank-specific cannibalization or seasonal structures. Data setup 108 pre-processes the sales data for promotion activities to build the promotion calendar, which is combined with the transaction history. Data setup 108 insures accuracy, effectiveness, and efficiency of the data for demand model 110.

Demand model 110 can use any one, two, or all three of the outlined acquisition model, average balance model, and TD renewal model to predict customer buying behavior, particularly with respect to changes in interest rates as applied to financial products 12, as described above. Demand model 110 can also use cannibalization, seasonality, promotional, and TDD modeling, as described above, to isolate and more accurately predict the effect of changing interest rates on financial products. The demand model reads transactional and attribute data and dynamically determines the individual model parameters for each deposit product, as described in equations (1)-(17). Each run of the demand model operates on a hierarchy determined by the model key, e.g., acquisition model for MMDA, or TD renewal model for CDs. Within each market group, the model processes one instance of the modeling hierarchy at a time. This approach allows for a high level of parallelization and scalability with a large amount of transactional data. The model driven processes load the input data, including all parameters and hierarchy information. For example, the model may load two years of transactional and portfolio data in weekly or monthly feed. The model runs through a Bayesian estimation process that obtains the values of parameters in previously described models such that the probability of observing the data given the model parameters is maximized. The model uses an iterative algorithm to solve the non-linear equations associated with the Bayesian estimation process. After convergence is reached, a fitness test is applied to verify that the model parameters are statistically significant and correct. Once all criteria are met for exiting the processing loops, the results are written to the database.

After the model parameters are obtained, optimization 120 computes volume forecasts for each product at different interest rates. The combined volume-rate trade-off information is used in the optimization process to generate optimal interest rates for each deposit product of bank 10.

The interest rate optimization 120 also receives business rules 114 based on bank business and product strategies 112, and bank profit metric and KPI 116. The interest rate optimization 120 reads the demand modeling output and combines the model parameters with cost metrics to generate a set of optimal rates subject to certain business constraints. The recommended optimal interest rate file is displayed through a user interface or exported to an external storage device in price file 124 which is exported to bank price distribution system 126 to make the model output available to bank 10.

The combined volume-rate trade-off information can be used by an end user in what-if analysis 128 to generate the optimal interest rate for each deposit product in a deposit portfolio and to achieve enterprise level strategic goals. The demand model generates volume forecasts for each pricing portfolio at different rates.

The analysis of report 130, as generated by demand model 110 and optimization 120, helps explain the effect of interest rate variation on unit sales, revenue, and profitability. Understanding the cause and effect behind interest rates is important to increasing the profitability of the bank.

FIG. 9 illustrates a simplified computer system 150 for executing the software program used in the demand model and interest rate optimization process. Computer system 150 is a general-purpose computer including a central processing unit or microprocessor 152, mass storage device or hard disk 154, electronic memory 156, and communication port 158. Communication port 158 represents a modem, high-speed Ethernet link, or other electronic connection to transmit and receive input/output (I/O) data with respect to other computer systems.

Computer 150 is shown connected to communication network 160 by way of communication port 158. Communication network 160 can be a local and secure communication network such as an Ethernet network, global secure network, or open architecture such as the Internet. Computer system 162 can be configured as shown for computer 150 or dedicated and secure data terminals. Computer 162 is also connected to communication network 150. Computers 150 and 162 transmit and receive information and data over communication network 160.

When used as a standalone unit, computer 150 can be located in any convenient location. When used as part of a computer network, computers 150 and 162 can be physically located in any location with access to a modem or communication link to network 160. For example, computer 150 can be located in the main office of bank 10 and allows for multiple user access through the web. Alternatively, the computers can be mobile and accompany the users to any convenient location, e.g., remote offices, customer locations, hotel rooms, residences, vehicles, public places, or other locales with electronic access to communication network 160.

Each of the computers runs application software and computer programs which can be used to display user-interface screens, execute the functionality, and provide the features of the aforedescribed demand model and interest rate optimization process. In one embodiment, the screens and functionality come from the application software, i.e., the system runs directly on one of the computer systems. Alternatively, the screens and functionality can be provided remotely from one or more websites on the Internet. The websites are generally restricted-access and require passwords or other authorization for accessibility. Communications through such websites may be encrypted using secure encryption algorithms. Alternatively, the screens and functionality are accessible only on the secure private network, such as Virtual Private Network (VPN), with proper authorization.

The software is originally provided on computer-readable media, such as compact disks (CDs), magnetic tape, or other mass storage medium. Alternatively, the software is downloaded from electronic links such as the host or vendor website. The software is installed onto the computer system hard drive 154 and/or electronic memory 156, and is accessed and controlled by the computer's operating system. Software updates are also electronically available on mass storage media or downloadable from the host or vendor website. The software, as provided on the computer-readable media or downloaded from electronic links, represents a computer program product usable with a programmable computer processor having a computer-readable program code embodied within the computer program product. The software contains one or more programming modules, subroutines, computer links, and compilations of executable code, which perform the functions of the demand model and interest rate optimization process. The user interacts with the software via keyboard, mouse, voice recognition, and other user-interface devices connected to the computer system.

The software stores information and data related to the demand model and interest rate optimization in a database or file structure located on any one of, or combination of, hard drives 154 of the computers 150 or 162. More generally, the information can be stored on any mass storage device accessible to computers 150 and 162. The mass storage device may be part of a distributed computer system.

In the case of Internet-based websites, the interface screens are implemented as one or more webpages for receiving, viewing, and transmitting information related to the demand model and interest rate optimization. A host service provider may set up and administer the website from computer 162 located in the service provider's home office.

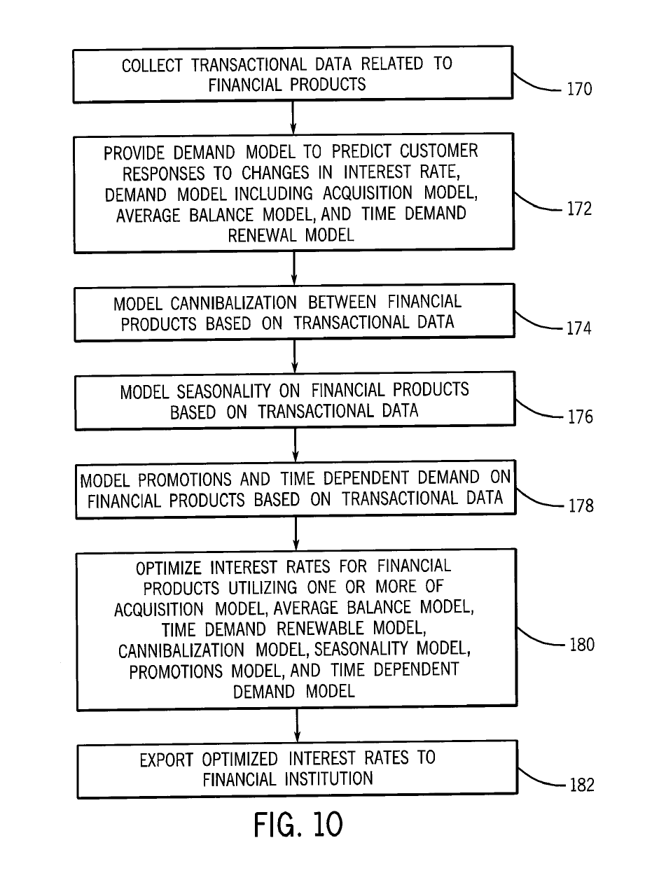

As further explanation, FIG. 10 illustrates a process flowchart of one embodiment of the demand model and interest rate optimization process. Step 170 collects transactional data related to a plurality of financial products. The financial products include demand deposits and time deposits. Step 172 provides a demand model to predict customer responses to changes in interest rate. The demand model includes an acquisition model for quantifying relationships between the financial products and interest rates and predicting volume for each of the financial products based on the transactional data, an average balance model for quantifying relationships between temporal average balances of the financial products and interest rates based on the transactional data, and a time demand renewable model for quantifying relationships between probability of renewals and interest rates for each of the financial products based on the transactional data. The demand model evaluates consumer response through account opening, balance variations, and time deposit renewals. Step 174 models cannibalization between the financial products based on the transactional data. The cannibalization modeling includes estimating model parameters by demand group level, categorical level, and multicurrency level. Step 176 models seasonality on the financial products based on the transactional data. Step 178 models promotions and time-dependent demand on the financial products based on the transactional data. When possible, multiple modeling steps can be combined to produce a simultaneous modeling approach. Step 180 optimizes interest rates for each of the financial products utilizing one or more of the acquisition model, average balance model, time demand renewable model, cannibalization model, seasonality model, promotions model, and time-dependent demand model within the demand model. Step 182 exports the optimized interest rates to a financial institution.

While one or more embodiments of the present invention have been illustrated in detail, the skilled artisan will appreciate that modifications and adaptations to those embodiments may be made without departing from the scope of the present invention as set forth in the following claims.

What is claimed is:

1. A computer-implemented method of modeling a financial product, comprising:
collecting transactional data related to a plurality of financial products;
providing a demand model to predict customer responses to changes in interest rate, the demand model including
(a) an acquisition model for quantifying relationships between the financial products and interest rates and predicting volume for the financial products based on the transactional data,
(b) an average balance model for quantifying relationships between temporal average balances of the financial products and interest rates based on the transactional data, and
(c) a time demand renewable model for quantifying relationships between probability of renewals and interest rates for the financial products based on the transactional data;
optimizing interest rates for the financial products utilizing the demand model; and
exporting the optimized interest rates to a financial institution.

2. The computer-implemented method of claim 1, further including modeling cannibalization between the financial products based on the transactional data.

3. The computer-implemented method of claim 1, wherein modeling cannibalization includes estimating model parameters by demand group level, categorical level, and multicurrency level.

4. The computer-implemented method of claim 1, further including modeling seasonality on the financial products based on the transactional data.

5. The computer-implemented method of claim 1, further including modeling promotions and time-dependent demand on the financial products based on the transactional data.

6. The computer-implemented method of claim 1, wherein the financial products include demand deposits and time deposits.

7. The computer-implemented method of claim 1, wherein the demand model evaluates consumer response through account opening, balance variations, and time deposit renewals.

8. A computer-implemented method of modeling a financial product, comprising:
collecting transactional data related to a plurality of financial products;
providing a demand model including an acquisition model, average balance model, and time demand renewable model for predicting customer responses to changes in a financial product attribute based on the transactional data;
optimizing the attribute for the financial products by utilizing one or more of the acquisition model, average balance model, and time demand renewable model; and
exporting the optimized attribute to a financial institution.

9. The computer-implemented method of claim 8, further including modeling cannibalization between the financial products based on the transactional data.

10. The computer-implemented method of claim 9, wherein modeling cannibalization includes estimating model parameters by demand group level, categorical level, and multicurrency level.

11. The computer-implemented method of claim 8, further including modeling seasonality on the financial products based on the transactional data.

12. The computer-implemented method of claim 8, further including modeling promotions and time-dependent demand on the financial products based on the transactional data.

13. The computer-implemented method of claim 8, wherein the financial product attribute is interest rate.

14. A computer program product usable with a programmable computer processor having a computer readable program code embodied therein, comprising:
computer readable program code which collects transactional data related to a plurality of financial products;
computer readable program code which provides a demand model including an acquisition model, average balance model, and time demand renewable model for predicting customer responses to changes in a financial product attribute based on the transactional data;
computer readable program code which optimizes the attribute for the financial products by utilizing one or more of the acquisition model, average balance model, and time demand renewable model; and
computer readable program code which exports the optimized attribute to a financial institution.

15. The computer program product of claim 14, further including computer readable program code which models cannibalization between the financial products based on the transactional data.

16. The computer program product of claim 15, wherein modeling cannibalization includes estimating model parameters by demand group level, categorical level, and multicurrency level.

17. The computer program product of claim 14, further including computer readable program code which models seasonality on the financial products based on the transactional data.

18. The computer program product of claim 14, further including computer readable program code which models promotions and time-dependent demand on the financial products based on the transactional data.

19. The computer program product of claim 14, wherein the financial product attribute is interest rate.

20. A computer system for modeling a financial product, comprising:
means for collecting transactional data related to a plurality of financial products;
means for providing a demand model including an acquisition model, average balance model, and time demand renewable model for predicting customer responses to changes in a financial product attribute based on the transactional data;
means for optimizing the attribute for the financial products by utilizing one or more of the acquisition model, average balance model, and time demand renewable model; and
means for exporting the optimized attribute to a financial institution.

21. The computer system of claim 20, further including means for modeling cannibalization between the financial products based on the transactional data.

22. The computer system of claim 21, wherein modeling cannibalization includes estimating model parameters by demand group level, categorical level, and multicurrency level.

23. The computer system of claim 20, further including means for modeling seasonality on the financial products based on the transactional data.

24. The computer system of claim 20, further including means for modeling promotions and time-dependent demand on the financial products based on the transactional data.

25. The computer system of claim 20, wherein the financial product attribute is interest rate.
